(19) United States
(12) Patent Application Publication
(10) Pub. No.: US 2023/0054667 A1
(43) Pub. Date: Feb. 23, 2023

(54) APPARATUS AND METHODS FOR CUSTOMIZING SEAMS OF A SPORT BALL

(71) Applicant: Ball Different, LLC, Crystal Lake, IL (US)

(72) Inventors: Bennett C. Barr, Crystal Lake, IL (US); Nathaniel P. Koteras, Crystal Lake, IL (US)

(73) Assignee: Ball Different, LLC, Crystal Lake, IL (US)

(21) Appl. No.: 17/819,674

(22) Filed: Aug. 15, 2022

Related U.S. Application Data
(60) Provisional application No. 63/234,401, filed on Aug. 18, 2021.

(51) Int. Cl. C09J 7/38; A63B 41/08; B29C 65/50; C09J 7/24; C09J 5/00

(52) U.S. Cl. CPC C09J 7/383; A63B 41/08; B29C 65/50; C09J 7/245; C09J 5/00; B29L 2031/54

(57) ABSTRACT

A tape is disclosed for use with a ball having a seam, wherein the seam has a predetermined seam color. The tape includes an adhesive layer formed of an adhesive material configured to attach to the seam, and a carrier layer formed of a carrier layer material, wherein the carrier layer has a custom color that is different than the predetermined seam color. Additionally, methods are disclosed for customizing a color of the seam of the ball using multiple tape segments. Still further, a kit is disclosed that includes the ball, a first tape having a first custom color, and a second tape having a second custom color.

### BACKGROUND

### Technical Field

The present disclosure generally relates to balls or projectiles used in sports, games, or play, and more particularly to apparatus and methods for modifying the appearance of seams provided on such balls.

### Description of the Related Art

Various types of balls are known for use in sports, games, or play. Some balls are fabricated by joining together multiple components which, when finally assembled, result in exterior seams. Basketballs, for example, may be constructed with a carcass, which may include an inflatable rubber bladder, bonded to an outer cover, which may include multiple panels. Adjacent panels are separated by gaps or seams, which can improve a user's ability to grip the ball.

Currently, the color of the seams provided on a ball is determined by the manufacturer. That color is often dictated by the materials used. For example, a basketball typically has black seams. Alternatively, the manufacturer may use color pigments in the materials, or add an additional color layer, to provide seams in colors other than black. Whether provided in black or another color, the color of the seams is permanent.

### SUMMARY OF THE DISCLOSURE

In accordance with one aspect of the present disclosure, a tape is provided for use with a ball having a seam, wherein the seam has a predetermined seam color. The tape includes an adhesive layer formed of an adhesive material configured to attach to the seam, and a carrier layer formed of a carrier layer material, wherein the carrier layer has a custom color that is different than the predetermined seam color.

In accordance with another aspect of the present disclosure, a method of customizing a color of a seam of a ball is provided, wherein the seam has a predetermined seam color and includes a figure-eight seam, a first circumferential seam, and a second circumferential seam. The method includes applying a first segment of tape to the figure-eight seam, applying a second segment of tape to the first circumferential seam, and applying a third segment of tape to the second circumferential seam. Each of the first, second, and third segments of tape comprise an adhesive layer configured to attach to the seam, and a carrier layer formed of a carrier layer material, wherein the carrier layer has a custom color that is different than the predetermined seam color.

In accordance with yet another aspect of the present disclosure, a kit includes a ball having a seam with a predetermined seam color, a first tape having a first tape adhesive layer and a first tape carrier layer, wherein the first tape carrier layer has a first custom color that is different from the predetermined seam color, and a second tape having a second tape adhesive layer and a second tape carrier layer, wherein the second tape carrier layer has a second custom color that is different from the predetermined seam color.

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is a perspective view of a ball having seams;

FIG. 2 is an isometric view of a tape for applying to the ball of FIG. 1;

FIG. 3 is a schematic block diagram of a method of applying the tape of FIG. 2 to the ball of FIG. 1;

FIG. 4 is a perspective view showing a first segment of the tape of FIG. 2 applied to a figure-eight seam of the ball of FIG. 1;

FIG. 5 is a perspective view showing a second segment of the tape of FIG. 2 applied to a first circumferential seam of the ball of FIG. 1;

FIG. 6 is a perspective view showing a third segment of the tape of FIG. 2 applied to a second circumferential seam of the ball of FIG. 1;

FIG. 7 is a perspective view of a kit including a ball, a first tape, and a second tape.

It should be understood that the drawings are not necessarily to scale and that the disclosed embodiments are sometimes illustrated diagrammatically and in partial views. In certain instances, details which are not necessary for an understanding of the disclosed methods and apparatus or which render other details difficult to perceive may have been omitted. It should be understood, of course, that this disclosure is not limited to the particular embodiments illustrated herein.

### DETAILED DESCRIPTION

Apparatus and methods are described herein that permit the color of a seam provided on a ball to be customized by an end user. In some examples of the present disclosure, an apparatus is provided as a tape having a carrier layer and an adhesive layer. The carrier layer has a custom color that is different from the seam color. The carrier layer may also be formed of a carrier layer material that is highly conformable and resistant to aging, sun, water, oil, abrasion, impact, and rupture. In other examples of the present disclosure, a method is provided in which a tape is applied to the seams of a ball. In some methods, the ball is a basketball, and the tape is applied in multiple steps. In still other examples of the present disclosure, a kit is provided that includes a ball and one or more tapes. The ball is formed with seams, and a first tape is provided having a first custom color. A second tape and subsequent tapes may also be provided, wherein each additional tape has a unique color that is different from the seam color and the other tape colors.

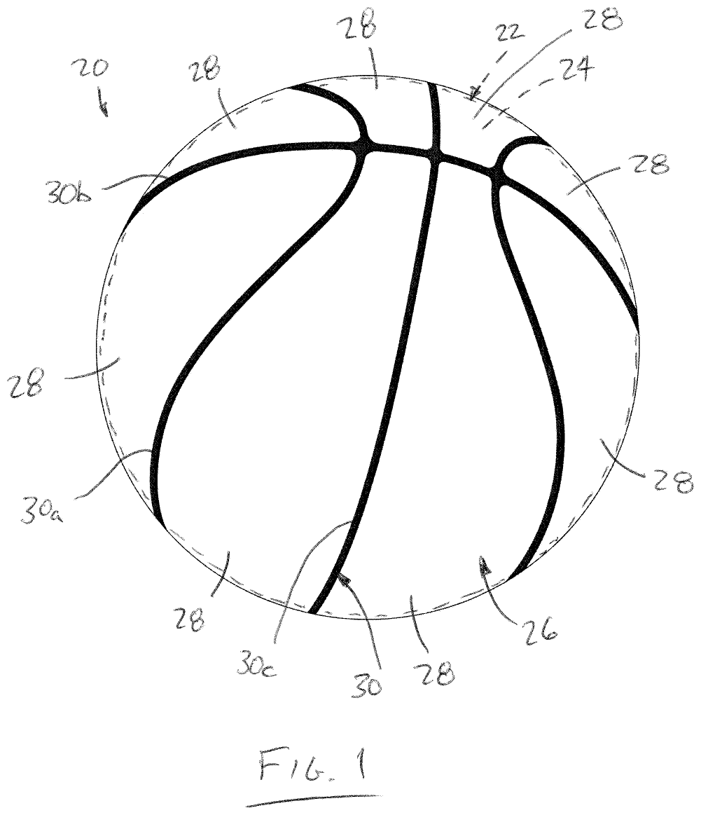

Referring to FIG. 1, a conventional ball is shown in the form of a basketball 20. The basketball 20 includes a carcass 22, which includes a bladder 24. An outer cover 26 is coupled to the carcass 22, and includes of a plurality of outer cover panels 28. Gaps between adjacent cover panels 28 provide seams 30, which may be formed by outwardly extending portions of the carcass 22 or separate ribs (not shown) attached to an exterior of the carcass 22. The seams 30 are provided in a predetermined seam color, typically black. In the illustrated embodiment, the seams 30 include a figure-eight seam 30a, a first circumferential seam 30b, and a second circumferential seam 30c.

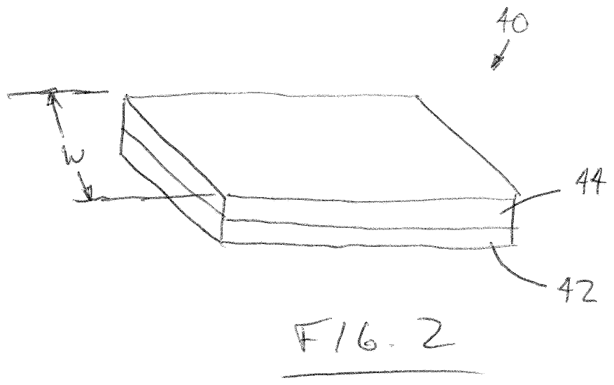

FIG. 2 illustrates a tape 40 which may be applied over the seams 30 to customize the color of the seams 30. More specifically, the tape 40 has an adhesive layer 42 and a carrier layer 44. The adhesive layer 42 is formed of an adhesive layer material suitable for attachment to the seams 30 of the ball 20. In some examples, the adhesive material does not form a permanent bond with the seams 30 but instead permits subsequent removal when appropriate force is applied. An exemplary adhesive layer that adequately bonds to the seams 30 while permitting subsequent removal is synthetic rubber resin.

The carrier layer 22 is formed of a carrier layer material that is durable and that can maintain integrity over extended periods of use. For example, the carrier layer material is highly conformable and resistant to aging, sun, water, oil, abrasion, impact, and rupture. Additionally, the carrier layer material does not impact performance of the ball 20 during use. In certain examples, the carrier layer material is a soft polyvinyl chloride (SPVC) film, have a thickness of approximately 3-5 mils. The tape 40 may have a tape width W that substantially matches a seam width. For example, the tape width may be approximately 0.25 inches. The carrier layer 22 further may be provided in a custom color that is different from the predetermined seam color. For example, the custom color may be yellow, white, black, red, orange, light blue, dark blue, gray, purple, emerald green, Kelly green, brown, or other color.

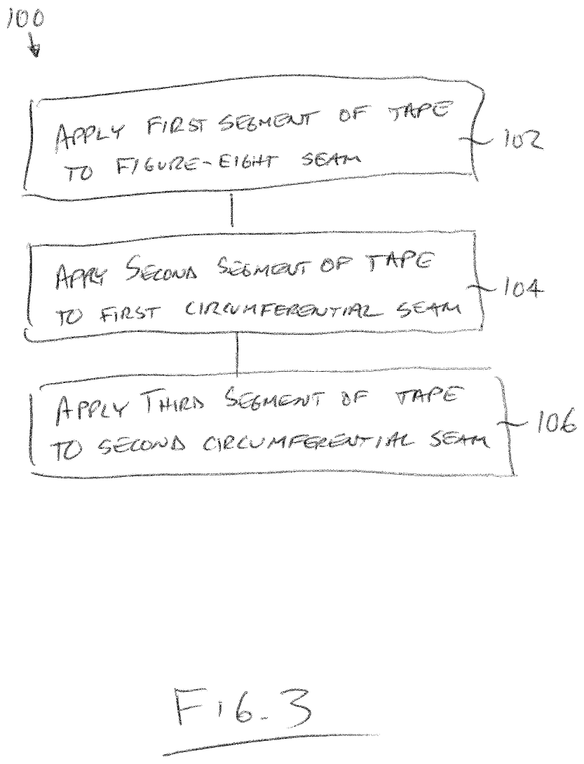

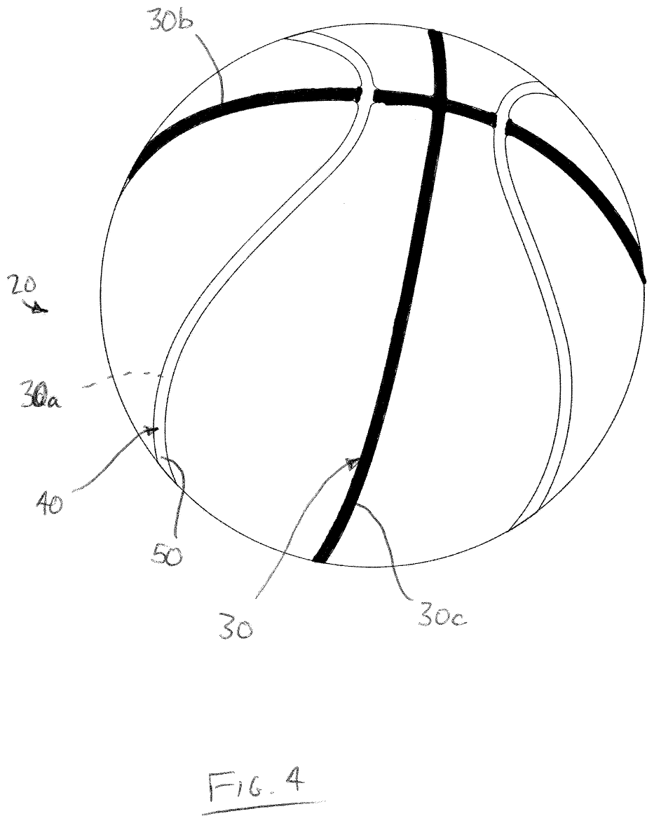

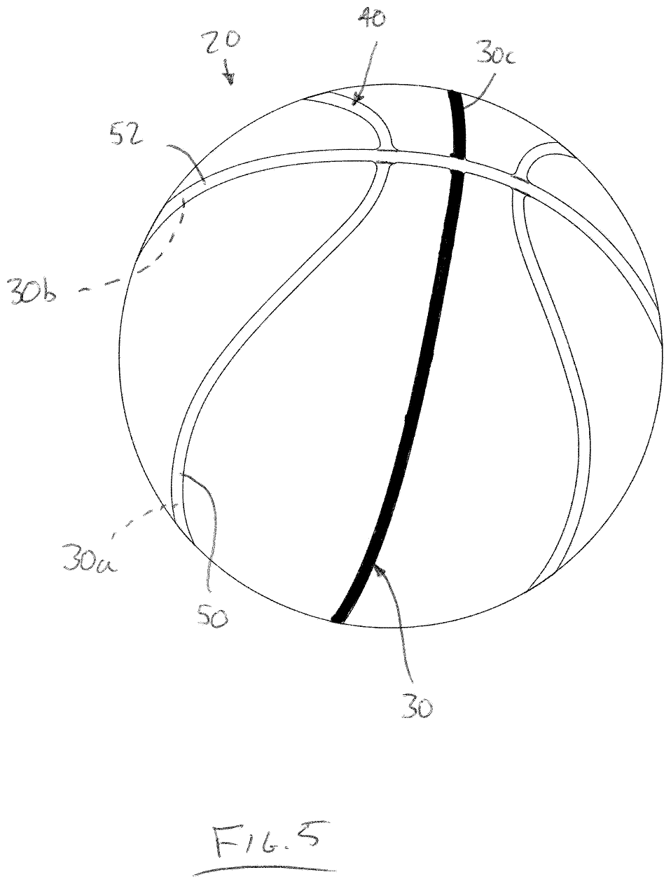

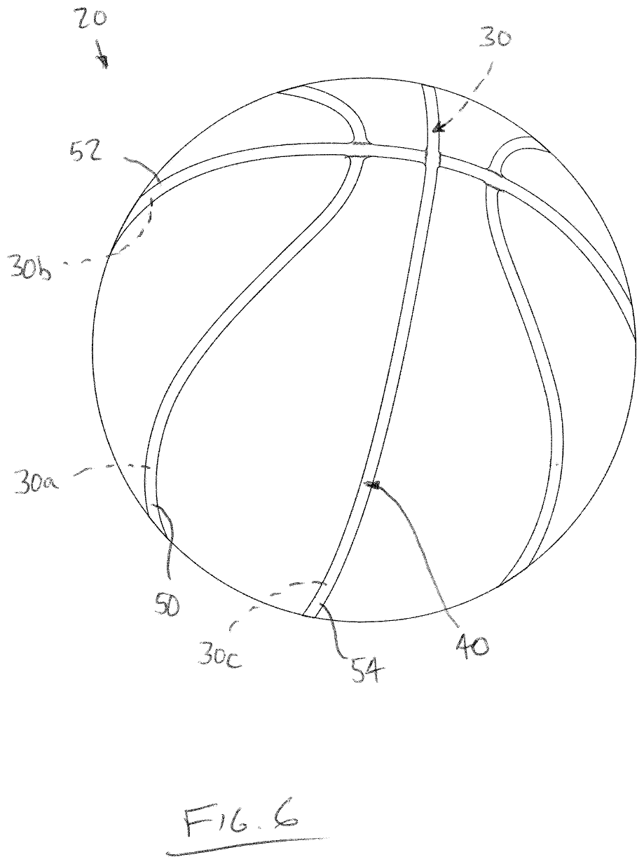

FIG. 3 schematically illustrates a method 100 of customizing a color of the seam 30 of the ball 20. The method 100 begins at block 102, where a first segment of tape 50 is applied to the figure-eight seam 30a, as best shown in FIG. 4. The method 100 continues at block 104 by applying a second segment of tape 52 to the first circumferential seam 30b (FIG. 5). At block 106, the method 100 includes applying a third segment of tape 54 to the second circumferential seam 30c (FIG. 6). At this point, all seams 30 of the ball 20 have been covered by the tape 40, so that the seams 30 appear to have the custom color of the tape 40.

Optionally, the method 100 may further include changing the appearance of the seams 30 to have a second custom color. Accordingly, the first, second, and third segments of tape 50, 52, 54, having the first custom color are removed, and first, second, and third segments of tape having a second custom color are applied to the seams 30.

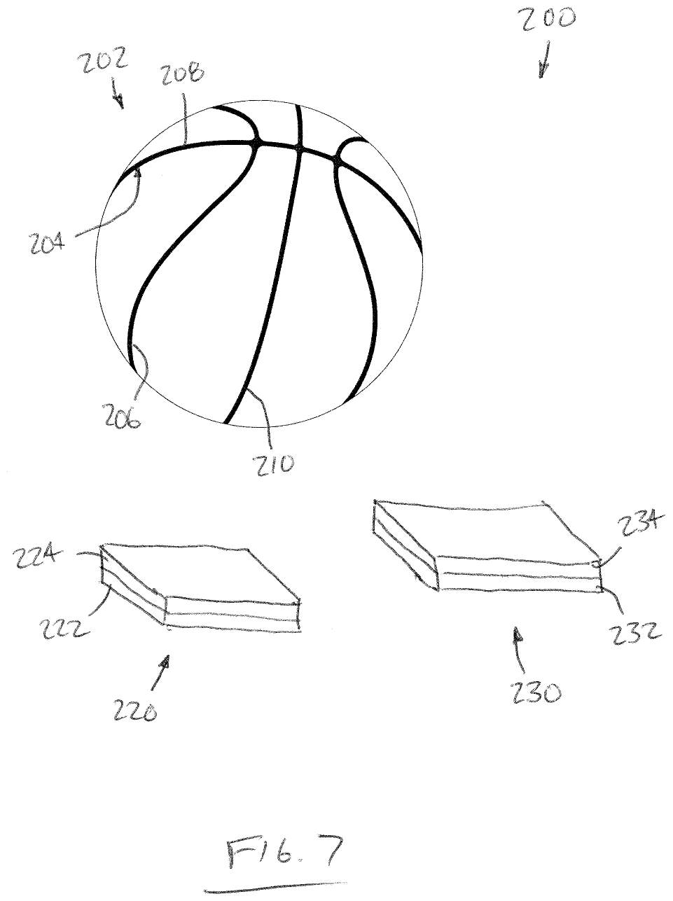

In yet further examples, a kit 200 may be provided for that permits multiple custom colors to be applied. As best shown in FIG. 7, the kit 200 includes a ball 202 having seams 204. In the illustrated embodiment, the ball 202 is a basketball, and the seams 204 include a figure-eight seam 206, a first circumferential seam 208, and a second circumferential seam 210. The kit 200 further includes a first tape 220 having an adhesive layer 222 and a carrier layer 224. The carrier layer 224 has a first custom color that is different from a color of the seams 204. Additionally, the kit 200 may include a second tape 230 having an adhesive layer 232 and a carrier layer 234. The carrier layer 234 has a second custom color that is different from a color of the seams 204. In some examples, the kit 200 includes more than two tapes, wherein each additional tape has a custom color that is different from the other tape colors provided in the kit 200.

Where the kit 200 includes at least two tapes 220, 230, with each tape 220, 230 having a different custom color, it will be appreciated that each tape may be applied to only a portion of the seams 204 to provide a multi-colored seam appearance. That is, the first tape 220 may be applied to all, or portions of, a sub-set of the figure-eight seam 206, the first circumferential seam 208, and the second circumferential seam 210, while the second tape 230 is applied to the portions of the seams 204 not covered by the first tape 210.

All references, including publications, patent applications, and patents, cited herein are hereby incorporated by reference. The description of certain embodiments as “preferred” embodiments, and other recitation of embodiments, features, or ranges as being preferred, is not deemed to be limiting, and the claims are deemed to encompass embodiments that may presently be considered to be less preferred. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. The description herein of any reference or patent, even if identified as “prior,” is not intended to constitute a concession that such reference or patent is available as prior art against the present disclosure.

What is claimed is:

1. A tape for use with a ball having a seam, wherein the seam has a predetermined seam color, the tape comprising:
an adhesive layer formed of an adhesive material configured to attach to the seam; and
a carrier layer formed of a carrier layer material, wherein the carrier layer has a custom color that is different than the predetermined seam color.

2. The tape of claim 1, wherein the adhesive material comprises a releasable adhesive material.

3. The tape of claim 2, wherein the releasable adhesive material comprises synthetic rubber resin.

4. The tape of claim 1, wherein the carrier layer material is highly conformable and resistant to aging, sun, water, oil, abrasion, impact, and rupture.

5. The tape of claim 4, wherein the carrier layer material comprises soft polyvinyl chloride film.

6. The tape of claim 5, wherein the carrier layer has a thickness of approximately 3-5 mils.

7. The tape of claim 1, wherein the seam has a seam thickness, and wherein the tape has a tape thickness substantially equal to the seam thickness.

8. The tape of claim 7, wherein the tape thickness is approximately 0.25 inches.

9. The tape of claim 1, wherein the custom color is one of yellow, white, black, red, orange, light blue, dark blue, gray, purple, emerald green, Kelly green, or brown.

10. The tape of claim 1, wherein the seam comprises a figure-eight seam, a first circumferential seam, and a second circumferential seam, and wherein the tape comprises:
a first segment sized to cover the figure-eight seam;
a second segment sized to cover the first circumferential seam; and
a third segment sized to cover the second circumferential seam.

11. A method of customizing a color of a seam of a ball, wherein the seam has a predetermined seam color and includes a figure-eight seam, a first circumferential seam, and a second circumferential seam, the method comprising:
applying a first segment of tape to the figure-eight seam;
applying a second segment of tape to the first circumferential seam; and
applying a third segment of tape to the second circumferential seam; and
wherein each of the first, second, and third segments of tape comprise an adhesive layer configured to attach to the seam, and a carrier layer formed of a carrier layer material, wherein the carrier layer has a custom color that is different than the predetermined seam color.

12. The method of claim 11, wherein:
a portion of at least one of the first, second, and third segments of tape comprises a first custom color; and
another portion of the at least one of the first, second, and third segments of tape comprises a second custom color.

13. A kit, comprising:
a ball having a seam with a predetermined seam color;
a first tape having a first tape adhesive layer and a first tape carrier layer, wherein the first tape carrier layer has a first custom color that is different from the predetermined seam color; and
a second tape having a second tape adhesive layer and a second tape carrier layer, wherein the second tape carrier layer has a second custom color that is different from the predetermined seam color.
